(19) United States
(12) Patent Application Publication
(10) Pub. No.: US 2022/0153142 A1
(43) Pub. Date: May 19, 2022

(54) DRIVE UNIT FOR AN ELECTRIC VEHICLE AND METHOD FOR DETECTING FAULTS IN A DRIVE UNIT

(71) Applicant: Robert Bosch GmbH, Stuttgart (DE)

(72) Inventors: Sebastian Ihrle, Deckenpfronn (DE); Reiner Hemmert, Reutlingen (DE)

(21) Appl. No.: 17/430,682

(22) PCT Filed: Feb. 5, 2020
(86) PCT No.: PCT/EP2020/052859

§ 371 Date: Aug. 12, 2021

(30) Foreign Application Priority Data
Feb. 14, 2019 (DE) 10 2019 201 971.4

(51) Int. Cl. B60L 15/00; B60L 3/00

(52) U.S. Cl. CPC B60L 15/007; B60L 3/0061; B60L 2270/142; B60L 2240/486; B60L 2270/145; B60L 2240/14

(57) ABSTRACT

The invention relates to a drive unit (10) for an electric vehicle, said drive unit comprising an electric motor (20), a transmission (30), a power electronics unit (40) for controlling the electric motor (20), and an acceleration sensor (50). The acceleration sensor (50) is located in a housing (42) of the power electronics unit (40), and the housing (42) of the power electronics units (40) is mechanically coupled to the electric motor (20) and/or to the transmission (30) such that vibrations generated by the electric motor (20) and/or by the transmission (30) are transmitted to the acceleration sensor (50) located in the housing (42) of the power electronics unit (40), said acceleration sensor being designed to pick up the transmitted vibrations and convert said vibrations into a measurement signal. The drive unit (10) comprises a signal processing unit which is designed to generate an order spectrogram from the measurement signal and from the speed of the electric motor (20). The invention also relates to a method for detecting faults in a drive unit (10) according to the invention, wherein vibrations which are generated by the electric motor (20) and/or by the transmission (30) are picked up by the acceleration sensor (50) and converted into a measurement signal, an order spectrogram is generated from the measurement signal and from the speed of the electric motor (20) using a signal processing unit, at least one level of the order spectrogram for at least one order is compared using a comparison unit with a threshold value assigned to said order, and a fault in the drive unit (10) is detected if the at least one level of the order spectrogram exceeds the threshold value assigned to said order.

### BACKGROUND OF THE INVENTION

The invention relates to a drive unit for an electric vehicle, said drive unit comprising an electric motor, a transmission, a power electronics unit for controlling the electric motor, and an acceleration sensor. The invention also relates to a method for detecting faults in a drive unit in accordance with the invention.

It becomes apparent that in future the use of motor vehicles that are configured as electric motor vehicles will increase. Such electric motor vehicles comprise one or more electrical drive units. For example, one drive unit is provided for each axle of the electric motor vehicle. Such a drive unit for an electric vehicle comprises for example an electric motor, a transmission and a power electronics unit for controlling the electric motor. In this case, the power electronics unit functions quasi as a type of engine control unit and provides inter alia the necessary electrical currents for the electric motor. High performance signal processors are provided in the power electronics unit so as to regulate the drive unit.

During the operation of the drive unit in the electric vehicle, vibrations occur that are transmitted to the power electronics unit. Intensified vibrations arise particularly in the case of wear that occurs and also in the case of mechanical damage to the electric motor and/or the transmission. These vibrations can be detected for example with the aid of acceleration sensors and can be evaluated by a signal processing unit using suitable signal processing methods.

The document DE 10 2014 114 124 A1 discloses a control system for a vehicle, in the present case an electrically driven scooter. In this case, the control system comprises an electric motor and a power electronics unit. The power electronics unit comprises a controller having an acceleration sensor. Values that are received by the acceleration sensor are evaluated by the controller.

The document DE 10 2017 205 861 B3 discloses a motor vehicle that comprises an energy supply unit in the form of a rechargeable battery and a drive in the form of an electric motor. A power electronics unit that communicates with a computing facility is provided for controlling the electric motor. The computing facility is connected to multiple sensors, inter alia to an acceleration sensor. The computing facility uses the information from the acceleration sensor to determine an operating state of the vehicle.

The document DE 10 2017 102 107 A1 discloses a method for analyzing an electric motor of a motor vehicle. In this case, a computing facility is provided that is connected to a sensor. The sensor is configured for example as a structure-borne sound sensor and is consequently able to detect vibro-acoustic signals, for example vibrations. By virtue of detecting the signals that are received by the sensor and evaluating said signals, it is possible to examine the electric motor for example for possible mechanical damage.

The document DE 10 2016 007 256 B4 discloses a motor vehicle that comprises a power electronics unit that is arranged in a housing. The vehicle comprises moreover a high voltage battery and also an electric motor. The power electronics unit serves to drive the motor vehicle. A mechanical impact switch is integrated in the housing of the power electronics unit.

### SUMMARY OF THE INVENTION

A drive unit for an electric vehicle is proposed. The drive unit comprises an electric motor, a transmission, a power electronics unit for controlling the electric motor and an acceleration sensor. The power electronics unit is preferably electrically connected to a traction battery of the electric vehicle and supplies an electrical current for driving the electric motor. For example, the power electronics unit comprises a power inverter or inverter that generates a three phase AC voltage for the electric motor from the DC voltage of the traction battery.

In accordance with the invention, the acceleration sensor is arranged in a housing of the power electronics unit. In this case, the housing of the power electronics unit is mechanically coupled to the electric motor and/or to the transmission in such a manner that vibrations that are generated by the electric motor and/or by the transmission are transmitted to the acceleration sensor that is arranged in the housing of the power electronics unit. The acceleration sensor is configured so as to receive the transmitted vibrations and to convert them into a measurement signal. In this case, the drive unit also comprises a signal processing unit that is configured so as to create an order spectrogram from the measurement signal of the acceleration sensor and from a rotational speed of the electric motor.

The created order spectrogram represents a dependence of the measurement signal upon the rotational speed of the electric motor. In this case, the changing rotational speed of the electric motor represents an excitation of the drive unit. The excitation frequency is consequently likewise changeable. The measurement signal represents a response of the drive unit to this excitation with a changeable excitation frequency. The measurement signal comprises a level and a frequency that are dependent in each case upon the excitation frequency.

In accordance with an advantageous configuration of the invention, the signal processing unit comprises a comparison unit. The comparison unit is configured so as to compare at least one level of the order spectrogram in the case of at least one order with a threshold value that is allocated to the order. In this case, an order is a relevant in particular whole number ratio of the frequency of the measurement signal to the excitation frequency, in other words to the rotational speed of the electric motor.

In accordance with one advantageous development of the invention, the signal processing unit comprises a scanning unit for scanning the measurement signal and for generating discrete-time and discrete-value measurement values. In this case, the scanning unit scans the measurement signal in particular in periodic time intervals. In this case, the scanning frequency also remains constant in the case of a changing rotational speed of the electric motor.

In accordance with a further advantageous development of the invention, the signal processing unit comprises a scanning unit for scanning the measurement signal and

for generating discrete-angle and discrete-value measurement values. In this case, the scanning unit scans the measurement signal in particular in the case of specific angles of rotation of the electric motor. In this case, the same number of measurement values are always generated during one rotation of the electric motor. In this case, the scanning frequency is proportional to the changing rotational speed of the electric motor.

It is preferred that the signal processing unit also comprises a digital signal processor. The digital signal processor is configured so as to perform a Fourier transformation or an almost Fourier transformation of the discrete-value measurement values. The discrete-value measurement values can be discrete-time measurement values as well as discrete-angle measurement values.

In accordance with a preferred configuration of the invention, the acceleration sensor is embodied as an MEMS sensor, in other words as a microelectromechanical system sensor. MEMS sensors are relatively cost-efficient and comprise a compact structure.

A method is also proposed for detecting faults in a drive unit that is in accordance with the invention and that comprises an electric motor, a transmission, a power electronics unit for controlling the electric motor, and an acceleration sensor.

In this case, vibrations that are generated by the electric motor and/or by the transmission are received by the acceleration sensor and converted into a measurement signal. An order spectrogram is created by a signal processing unit from the measurement signal and a rotational speed of the electric motor.

The created order spectrogram represents a dependence of the measurement signal upon the rotational speed of the electric motor. In this case, the changing rotational speed of the electric motor represents an excitation of the drive unit. The excitation frequency is consequently likewise changeable. The measurement signal represents a response of the drive unit to this excitation having a changeable excitation frequency. The measurement signal comprises a level and a frequency that are dependent in each case upon the excitation frequency.

In this case, at least one level of the order spectrogram in the case of at least one order is compared by a comparison unit with a threshold value that is allocated to the order. In this case, an order is a relevant in particular whole number ratio of the frequency of the measurement signal to the excitation frequency, in other words to the rotational speed of the electric motor.

A fault in the drive unit is detected if the at least one level of the order spectrogram exceeds the threshold value that is allocated to the order. The relevant threshold value is taken for example from a previously created desired order spectrum that has been created using a completely functional fault-free drive unit.

In accordance with an advantageous development of the invention, the measurement signal is scanned by a scanning unit, whereby discrete-time and discrete-value measurement values are generated. In this case, the measurement signal is scanned by the scanning unit in this case in particular in periodic time intervals. In this case, the scanning frequency also remains constant in the case of a changing rotational speed of the electric motor.

In accordance with a further advantageous development of the invention, the measurement signal is scanned by a scanning unit, whereby discrete-angle and discrete-value measurement values are generated. In this case, the measurement signal is scanned by the scanning unit in this case in particular in the case of specific angles of rotation of the electric motor. In this case, always the same number of measurement values are generated during one rotation of the electric motor. In this case, the scanning frequency is proportional to the changing rotational speed of the electric motor.

In accordance with a preferred development of the invention, a Fourier transformation or an almost Fourier transformation of the discrete-value measurement values is performed by a digital signal processor. The discrete-value measurement values can be discrete-time measurement values as well as discrete-angle measurement values.

A drive unit in accordance with the invention and a method in accordance with the invention for detecting faults in a drive unit can be advantageously used in an electric vehicle.

It is possible in a drive unit in accordance with the invention to detect in a simple manner mechanical faults, in particular in the electric motor and in the transmission. In this case the number of components necessary for detecting such faults is advantageously minimized. It is only necessary to arrange an acceleration sensor in the housing of the power electronics unit in such a manner that vibrations that are generated by the electric motor and/or by the transmission are transmitted to the acceleration sensor. In this case, it is possible to use in a particularly advantageous manner a compact and cost-efficient MEMS sensor. Measurement signals that are output by the acceleration receiver can be further processed by a signal processing unit and evaluated. A signal processing unit that is suitable for this purpose can be integrated in a simple manner in the power electronics unit. The method in accordance with the invention is based on the knowledge that mechanical faults, in particular in the electric motor and in the transmission cause in particular vibrations the frequency of which correspond to multiples of the rotational speed of the electric motor. By creating and evaluating an order spectrum, it is possible to detect and evaluate such vibrations also in the case of a changing rotational speed of the electric motor. Consequently, the method in accordance with the invention renders it possible to identify mechanical faults in a relatively simple manner by means of evaluating the measurement signal of the acceleration receiver.

It is possible by means of the method in accordance with the invention to test a drive unit in accordance with the invention prior to delivery to the customer. After the production procedure, an end-of-line test is performed for this purpose, wherein the created order spectrum is compared with a desired order spectrum. It is also possible to identify wear and damage to individual components of the drive unit. Changes in specific orders are indications of changes in a specific component that is allocated to these orders. It is also conceivable to acquire field load data. In this case, typical vibration loads are identified in the drive unit. It is possible to derive from this a component-specific field load and to use it in particular to improve the reliability assurance.

### BRIEF DESCRIPTION OF THE DRAWINGS

Embodiments of the invention are further explained with the aid of the drawings and the description below.

In the drawings:

FIG. 1 illustrates a schematic view of a drive unit for an electric vehicle,

FIG. 2 illustrates a schematic circuit diagram of the drive unit shown in FIG. 1 and

FIG. 3 illustrates a graphic view of a created order spectrogram of the drive unit.

### DETAILED DESCRIPTION

In the description below of the embodiments of the invention, like or similar elements are described by like reference numerals, wherein a description of these elements is not repeated in individual cases. The figures are only a schematic representation of the subject matter of the invention.

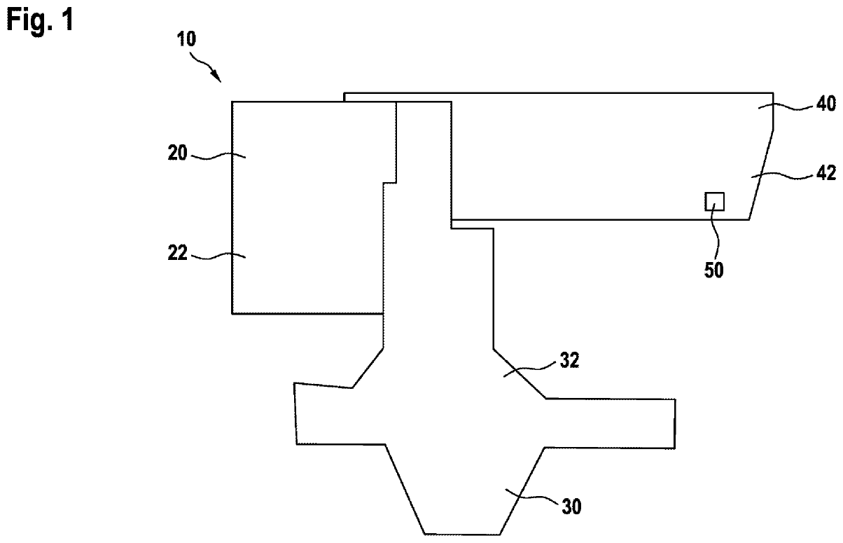

FIG. 1 illustrates a schematic view of a drive unit 10 for an electric vehicle. The drive unit 10 comprises an electric motor 20 having a housing 22. The drive unit 10 also comprises a transmission 30 having a housing 32. Moreover, the drive unit 10 comprises a power electronics unit 40 having a housing 42.

The housing 22 of the electric motor 20, the housing 32 of the transmission 30 and the housing 42 of the power electronics unit 40 are mechanically connected to one another in particular by means of screws (not illustrated in the figure).

Vibrations that are generated by or in one of the housings 22, 32, 42 are transmitted to the other housings 22, 32, 42. During the operation of the drive unit 10, vibrations are generated in particular by the electric motor 20 and by the transmission 30.

The drive unit 10 also comprises an acceleration sensor 50. The acceleration sensor 50 is arranged in this case in the housing 42 of the power electronics unit 40. The housing 42 of the power electronics unit 40 is, as already mentioned, mechanically coupled to the electric motor 20 and to the transmission 30 in such a manner that vibrations that are generated by the electric motor 20 and by the transmission 30 are transmitted to the acceleration sensor 50 that is arranged in the housing 42 of the power electronics unit 40.

The acceleration sensor 50 of the drive unit 10 is configured so as to receive the vibrations that are transmitted to it and to convert these vibrations into a measurement signal. The acceleration sensor 50 is embodied in the present case as an MEMS sensor, in other words as a microelectromechanical system sensor. The acceleration sensor 50 is consequently relatively cost-efficient and comprises a compact structure.

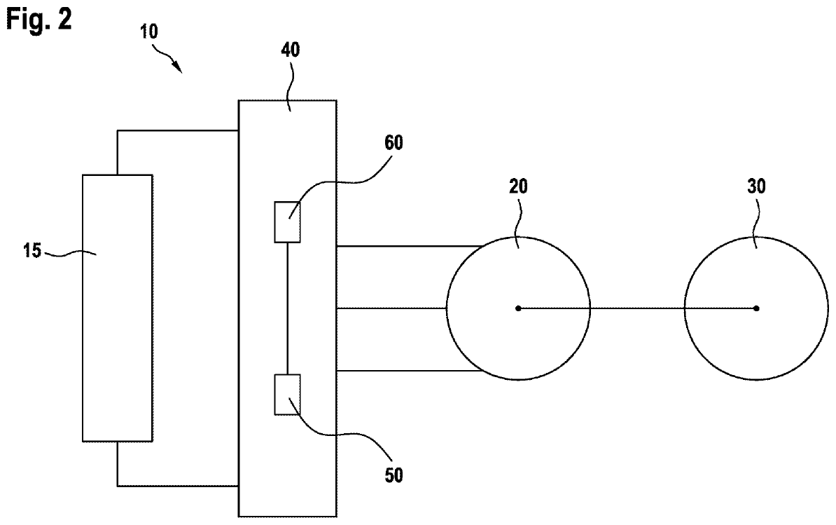

FIG. 2 illustrates a schematic circuit diagram of the drive unit 10 that is illustrated in FIG. 1 for an electric vehicle. The power electronics unit 40 serves to control the electric motor 20 and supplies an electrical current for driving the electric motor 20. The electric motor 20 is embodied in the present case as three-phase. The power electronics unit 40 is electrically connected by means of three-phase conductors to the electric motor 20.

The power electronics unit 40 of the drive unit 10 is electrically connected to a traction battery 15 of the electric vehicle. The traction battery 15 supplies in particular electrical energy for driving the electric vehicle. The power electronics unit 40 comprises a three-phase power inverter or inverter that from the DC voltage that is supplied by the traction battery 15 generates a three-phase AC voltage for controlling the three-phase electric motor 20.

The power electronics unit 40 of the drive unit 10 also comprises a signal processing unit 60 that is connected to the acceleration sensor 50. The signal processing unit 60 serves in particular so as to create an order spectrogram from the measurement signal of the acceleration sensor 50 and from a rotational speed of the electric motor 20.

The signal processing unit 60 of the power electronics unit 40 comprises a comparison unit. The comparison unit serves in particular so as to compare the level of the order spectrogram in the case of multiple orders with in each case a threshold value that is allocated to the order.

The signal processing unit 60 of the power electronics unit 40 also comprises a scanning unit. The scanning unit serves in particular to scan the measurement signal of the acceleration sensor 50 and to generate discrete-value measurement values. Depending upon the functioning principle of the scanning unit, the discrete-value measurement values can be discrete-time measurement values as well as discrete-angle measurement values.

For example, the scanning unit can scan the measurement signal in periodic time intervals. As a consequence, discrete-time measurement values are generated. In this case, the scanning frequency also remains constant in the case of a changing rotational speed of the electric motor 20. The scanning unit can also scan the measurement signal in the case of specific angles of rotation of the electric motor 20. As a consequence, discrete-angle measurement values are generated. In this case, the same number of measurement values are always generated during one rotation of the electric motor 20. In this case, the scanning frequency is proportional to the changing rotational speed of the electric motor 20.

The signal processing unit 60 of the power electronics unit 40 also comprises a digital signal processor. The digital signal processor serves in particular so as to perform a Fourier transformation or an almost Fourier transformation of the discrete-value measurement values. The discrete-value measurement values that are to be transformed can be discrete-time measurement values as well as discrete-angle measurement values.

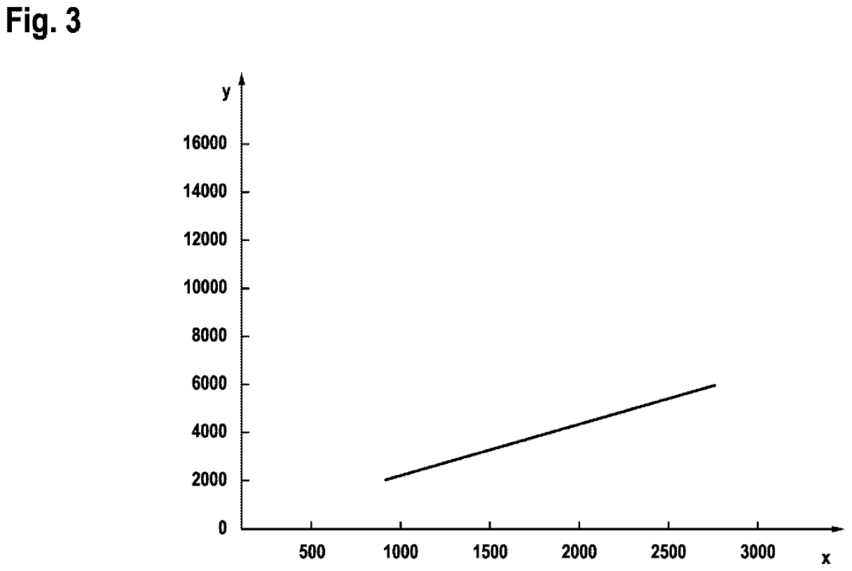

FIG. 3 illustrates a graphic illustration of an order spectrogram of the drive unit 10, said order spectrogram being created by the signal processing unit 60 that is illustrated in FIG. 2. In this case, the frequency of the measurement signal that is received by the acceleration sensor 50 is plotted in the unit “Hz” on the x-axis. The rotational speed of the electric motor 20 is plotted in the unit “rotations per minute” on the y-axis. An order in the present case is a ratio of the frequency of the measurement signal to the rotational speed of the electric motor 20. It is to be noted that in order to calculate the said ratio the rotational speed of the electric motor 20 must first be converted into the unit “Hz”.

In this case, only one order is illustrated in the order spectrogram, the level of said order having exceeded an allocated threshold value. As is apparent from the graphic illustration in FIG. 3, the ratio of the frequency of the received measurement signal to the rotational speed of the electric motor 20 in the case of the illustrated order is equal to 27. The level of the 27^{th} order of the order spectrogram therefore exceeds the allocated threshold value. A fault in the drive unit 10 is consequently detected.

The invention is not limited to the exemplary embodiments described here and the aspects mentioned in said exemplary embodiments. On the contrary, a multiplicity of variants that lie within the scope of professional expertise is possible within the range that is disclosed by the claims.

1. A drive unit (10) for an electric vehicle, said drive unit comprising an electric motor (20), a transmission (30), a power electronics unit (40) for controlling the electric motor (20), and an acceleration sensor (50),
wherein
the acceleration sensor (50) is arranged in a housing (42) of the power electronics unit (40) and the housing (42) of the power electronics unit (40) is mechanically coupled to the electric motor (20) and/or to the transmission (30) in such a manner that vibrations that are generated by the electric motor (20) and/or by the transmission (30) are transmitted to the acceleration sensor (50) that is arranged in the housing (42) of the power electronics unit (40), said acceleration sensor being configured so as to receive the transmitted vibrations and to convert them into a measurement signal, and
the drive unit (10) comprises a signal processing unit (60) that is configured to create an order spectrogram from the measurement signal and from a rotational speed of the electric motor (20).

2. The drive unit (10) as claimed in claim 1, wherein the signal processing unit (60) comprises a comparison unit that is configured so as to compare at least one level of the order spectrogram in the case of at least one order with a threshold value that is allocated to the order.

3. The drive unit (10) as claimed in claim 1, wherein
the signal processing unit (60) comprises a scanning unit for scanning the measurement signal and for generating discrete-time and discrete-value measurement values.

4. The drive unit (10) as claimed in claim 1, wherein
the signal processing unit (60) comprises a scanning unit for scanning the measurement signal and for generating discrete-angle and discrete-value measurement values.

5. The drive unit (10) as claimed in claim 3, wherein
the signal processing unit (60) comprises a digital signal processor that is configured so as to perform a Fourier transformation or an almost Fourier transformation of the measurement values.

6. The drive unit (10) as claimed in claim 1, wherein
the acceleration sensor (50) is embodied as an MEMS sensor.

7. A method for detecting faults in a drive unit (10) having an electric motor (20), a transmission (30), a power electronics unit (40) for controlling the electric motor (20), and an acceleration sensor (50), the method comprising:
receiving, via the acceleration sensor (50), vibrations that are generated by the electric motor (20) and/or by the transmission (30) and converting the same into a measurement signal,
creating an order spectrogram via the signal processing unit (60) from the measurement signal and from a rotational speed of the electric motor (20),
comparing at least one level of the order spectrogram via a comparison unit with a threshold value that is allocated to the at least one order, and
detecting a fault in the drive unit (10) when the at least one level of the order spectrogram exceeds the threshold value that is allocated to the order.

8. The method as claimed in claim 7, wherein
the measurement signal is scanned by a scanning unit, whereby discrete-time and discrete-value measurement values are generated.

9. The method as claimed in claim 7, wherein
the measurement signal is scanned by a scanning unit, whereby discrete-angle and discrete-value measurement values are generated.

10. The method as claimed in claim 8, wherein
a Fourier transformation or an almost Fourier transformation of the measurement values is performed by a digital signal processor.

11. An electric vehicle comprising a drive unit (10), the driving unit having an electric motor (20), a transmission (30), a power electronics unit (40) for controlling the electric motor (20), and an acceleration sensor (50),
wherein
the acceleration sensor (50) is arranged in a housing (42) of the power electronics unit (40) and the housing (42) of the power electronics unit (40) is mechanically coupled to the electric motor (20) and/or to the transmission (30) in such a manner that vibrations that are generated by the electric motor (20) and/or by the transmission (30) are transmitted to the acceleration sensor (50) that is arranged in the housing (42) of the power electronics unit (40), said acceleration sensor being configured so as to receive the transmitted vibrations and to convert them into a measurement signal, and
the drive unit (10) comprises a signal processing unit (60) that is configured to create an order spectrogram from the measurement signal and from a rotational speed of the electric motor (20).
